(19) United States
(12) Patent Application Publication
(10) Pub. No.: US 2007/0281206 A1
(43) Pub. Date: Dec. 6, 2007

(54) SEPARATOR FOR LITHIUM SECONDARY BATTERY, METHOD FOR PRODUCING THE SAME, AND LITHIUM SECONDARY BATTERY INCLUDING THE SAME

(75) Inventors: Masato FUJIKAWA, Osaka (JP); Shinji KASAMATSU, Osaka (JP); Mikinari SHIMADA, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/757,234

(22) Filed: Jun. 1, 2007

(30) Foreign Application Priority Data
Jun. 5, 2006 (JP) 2006-155745

(51) Int. Cl. H01M 10/50; H01M 2/16; B05D 3/02

(52) U.S. Cl. 429/62; 429/144; 427/385.5

(57) ABSTRACT

A separator for a lithium secondary battery includes a high molecular porous film with a shut-down function and a heat-resistant porous layer integrally formed on each side of the high molecular porous film. The heat-resistant porous layers contain a heat-resistant high-molecular material and a ceramic filler. By using the separator, the occurrence of a short-circuit due to the melting and shrinkage of the high molecular porous film is prevented. Also, in the event of a short-circuit and the generation of heat higher than the melting point of the material of the high molecular porous film, the expansion of the short-circuit is prevented, so that the safety of the lithium secondary battery is improved.

### FIELD OF THE INVENTION

The present invention relates to a separator for a lithium secondary battery, a method for producing the same, and a lithium secondary battery including the same.

### BACKGROUND OF THE INVENTION

Lithium secondary batteries, which are lightweight and have high energy density, are widely used as power sources for various electronic devices such as portable appliances.

Chemical batteries such as lithium secondary batteries generally include a positive electrode, a negative electrode, and a separator. The separator is disposed between the positive electrode and the negative electrode to electrically insulate the positive electrode from the negative electrode. The separator also serves to hold an electrolyte. In the case of lithium secondary batteries, the separator is usually a porous film of polyethylene or polypropylene having a large number of micropores therein. These pores serve as ion conductive paths for operating the battery. When the porous film is exposed to high temperatures, these pores are closed. This is called the shut-down function of the porous film. The use of such a porous film as the separator of a battery improves the safety of the battery since in the event of abnormal heat generation of the battery, the pores are closed so that battery operation is stopped.

The pores of a porous film with a shut-down function are usually formed by drawing. Thus, if extremely high temperature condition continues for a long time, the porous film undesirably melts and shrinks. The melting and shrinkage of the porous film cause a direct contact between the positive electrode and the negative electrode, thereby resulting in an internal short-circuit. Once an internal short-circuit occurs, the short-circuit current produces Joule's heat, so that the temperature of the short-circuited portion may locally exceed the melting point of the material of the porous film to cause an expansion of the short-circuited portion, thereby leading to overheating of the battery. Currently, the separator is becoming increasingly thinner as lithium secondary batteries are becoming higher in capacity and smaller in size. Therefore, the prevention or suppression of an internal short-circuit is an increasingly important technical problem to be solved.

Japanese Patent No. 3175730 proposes a separator including a porous film layer serving as a substrate and a heat-resistant layer. The porous film layer has a shut-down function, and the weight per unit area is 40 g/m² or less and the thickness is 70 μm or less. The heat-resistant layer comprises a heat-resistant, nitrogen-containing aromatic polymer and a ceramic powder. This technique is intended to suppress expansion of a short circuited portion of a porous film layer by providing a heat-resistant layer that resists melting even at high temperatures. However, due to the recent trend of higher capacity, higher output, and lower resistance of lithium secondary batteries, significantly increased amounts of Joule's heat is produced by an internal short-circuit. Under such circumstances, with this lamination structure of one porous film layer and one heat-resistant layer, it is difficult to prevent occurrence and expansion of a short circuit due to melting and shrinkage of the porous film layer, although deterioration of the heat-resistant layer itself may be prevented.

Also, Japanese Laid-Open Patent Publication No. Hei 11-144697 proposes a resin separator having a three-layer lamination structure of: one polyolefin porous film layer and two polyimide porous film layers formed on both sides of the polyolefin porous film layer in the thickness direction thereof. According to this technique, in view of the mechanical strength, durability, etc. of the separator, the polyolefin porous film layer needs to have a thickness of 25 to 50 μm and the polyimide porous film layers need to have a thickness of 25 to 150 μm. Hence, the separator of this technique has a relatively large thickness of 75 μm or more. Such thickness, however, is not suitable for providing a battery with high energy density. If the thickness is further reduced, the mechanical strength in particular of the separator may decrease.

Further, Japanese Laid-Open Patent Publication No. 2001-319634 proposes a separator having a laminated structure of one ceramic composite layer and one porous film layer. The ceramic composite layer comprises a matrix material and inorganic particles. Examples of the matrix material include polyethylene oxide, polyvinylidene fluoride, and polytetrafluoroethylene. Examples of the inorganic particles include silicon dioxide, aluminum oxide (alumina), calcium carbonate, titanium dioxide, and silicon disulfide. These matrix materials have insufficient heat resistance. Thus, in the event that a battery generates a high temperature heat, the ceramic composite layer including such a matrix material may melt, although it includes the inorganic particles, so that the mechanical strength may decrease and long-time use may become difficult. Therefore, even if the ceramic composite layer is laminated on the porous film layer (substrate) such as a polyolefin film, melting and shrinkage of the porous film layer cannot be sufficiently prevented.

### BRIEF SUMMARY OF THE INVENTION

The present invention relates to a separator including a porous film with a shut-down function, and an object of the present invention is to provide a separator for a lithium secondary battery which can suppress occurrence and expansion of a short circuit in the event of generation of heat that is higher than the melting point of the high molecular material of the porous film, and a method for producing such a separator.

Another object of the present invention is to provide a lithium secondary battery which is lightweight and has high energy density and excellent safety.

That is, the present invention relates to a separator for a lithium secondary battery, including: a high molecular porous film with a shut-down function; a first heat-resistant porous layer integrally formed on one face of the high molecular porous film, the first heat-resistant porous layer comprising a heat-resistant high-molecular material and a ceramic filler; and a second heat-resistant porous layer integrally formed on the other face of the high molecular porous film, the second heat-resistant porous layer comprising a heat-resistant high-molecular material and a ceramic filler.

The heat-resistant high-molecular material of the first and second heat-resistant porous layers is preferably a polyamideimide, and the ceramic filler of the first and second heat-resistant porous layers is preferably an alumina filler.

Also, the separator for a lithium secondary battery preferably has a thickness of 12 to 24 μm.

Preferably, 0.5≦Da/(Db1+Db2)≦8 where Da is the thickness of the high molecular porous film, Db1 is the thickness of the first heat-resistant porous layer, and Db2 is the thickness of the second heat-resistant porous layer.

Also, preferably 0.5≦Db1/Db2≦2.

Further, the high molecular porous film preferably has a porosity of 40 to 70% at 25° C.

Furthermore, the present invention also provides a separator for a lithium secondary battery, including: a high molecular porous film with a shut-down function, the high molecular porous film having a porosity of 40 to 70% at 25° C. and a thickness of Da; a first heat-resistant porous layer integrally formed on one face of the high molecular porous film, the first heat-resistant porous layer comprising a polyamideimide and an alumina filler and having a thickness of Db1; and a second heat-resistant porous layer integrally formed on the other face of the high molecular porous film, the second heat-resistant porous layer comprising a polyamideimide and an alumina filler and having a thickness of Db2. The sum of Da, Db1, and Db2 is 12 to 24 μm, 0.5≦Da/(Db1+Db2)≦8, and 0.5≦Db1/Db2≦2.

Also, the present invention pertains to a method for producing a separator for a lithium secondary battery. The method includes the steps of: immersing a high molecular porous film with a shut-down function in a coating liquid containing a heat-resistant high-molecular material or a precursor thereof and a ceramic filler; and taking the high molecular porous film out of the coating liquid and heat-drying it to form a heat-resistant porous layer on each side of the high molecular porous film.

Further, the present invention is directed to a lithium secondary battery including: the above-mentioned separator for a lithium secondary battery; a positive electrode including an active material which absorbs and desorbs lithium; a negative electrode including an active material which absorbs and desorbs lithium; and a non-aqueous electrolyte.

According to the present invention, the occurrence and expansion of a short-circuit is significantly reduced in spite of the use of a high molecular porous film with a shut-down function, and it is thus possible to provide a separator for a lithium secondary battery which can improve battery safety. Also, since the separator for a lithium secondary battery according to the present invention has suitable flexibility and porosity, it is applicable to batteries of various shapes while enabling stable high output of the battery.

Further, the present invention can provide a method for producing the separator for a lithium secondary battery of the present invention in an efficient, industrial, and advantageous manner.

Furthermore, the present invention can provide a lithium secondary battery that includes the separator for a lithium secondary battery of the present invention, has high energy density and high capacity, and is significantly excellent in high-output characteristics and safety.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 is a longitudinal sectional view schematically showing the structure of a lithium secondary battery 1 according to one embodiment of the present invention.

### DETAILED DESCRIPTION OF THE INVENTION

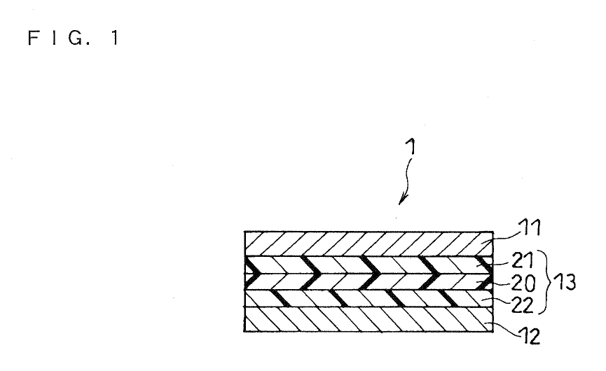

The lithium secondary battery of the present invention can have the same structure as those of conventional lithium secondary batteries except for the separator of the present invention. FIG. 1 is a longitudinal sectional view schematically showing the structure of a lithium secondary battery 1 according to one embodiment of the present invention. The lithium secondary battery 1 includes a positive electrode 11, a negative electrode 12, and a separator 13. In the lithium secondary battery 1, the positive electrode 11 and the negative electrode 12 are opposed to each other with the separator 13 interposed therebetween.

The positive electrode 11 includes a positive electrode current collector and a positive electrode active material layer, and the positive electrode active material layer is in contact with the separator 13 or faces the separator 13. The positive electrode current collector can be any material commonly used in the field of lithium secondary batteries, and examples include aluminum foil, aluminum alloy foil, etc. The positive electrode active material layer is provided on at least one face of the positive electrode current collector, and includes a positive electrode active material and, if necessary, a conductive agent, a binder, etc. The positive electrode active material can be any material commonly used in the field of lithium secondary batteries, and a composite oxide is preferably used. Examples of composite oxides include, but are not particularly limited to, lithium cobaltate, lithium nickelate, lithium manganate, etc. A modified composite oxide also can be used. As used herein, “modified composite oxide” refers to, for example, composite oxide obtained by replacing part of the metal atoms and/or the oxygen atoms in the crystal of the above-mentioned composite oxide with other atoms. These positive electrode active material can be used singly or, if necessary, in combination of two or more of them. Examples of conductive agents include acetylene black, ketjen black (registered trademark), various graphites, and mixtures thereof. Examples of binders include fluorocarbon resins such as polytetrafluoroethylene (hereinafter “PTFE”) and polyvinylidene fluoride (hereinafter “PVDF”), water-soluble high-molecular compounds such as carboxymethyl cellulose, rubbers such as styrene-butadiene rubber, and mixtures thereof.

The negative electrode 12 includes a negative electrode current collector and a negative electrode active material layer. The negative electrode active material layer is in contact with the separator 13 or faces the separator 13. The negative electrode current collector can be any material commonly used in the field of lithium secondary batteries, and copper foil is preferred. The negative electrode active material layer is provided on at least one face of the negative electrode current collector, and includes a negative electrode active material and, if necessary, a conductive agent, a binder, etc. The negative electrode active material can be any material commonly used in the field of lithium secondary batteries, and examples include carbon materials such as natural graphite, artificial graphite, and hard carbon, elements capable of being alloyed with lithium such as Al, Si, Zn, Ge, Cd, Sn, and Pb, oxides such as SnO and SiOx (0<x<2), and alloys including transition metal such as Ni—Si alloy and Ti—Si alloy. These negative electrode active materials can be used singly or, if necessary, in combination of two or more of them. The conductive agent can be the same as that used in the positive electrode active material layer. The binder can be any resin material commonly used in the field of lithium secondary batteries, and examples include PVDF and modified PVDF. Of course, without using a binder, the negative electrode active material layer may be formed on the surface of the negative electrode current collector by vapor deposition or the like.

The separator 13 includes a high molecular porous film 20, a first heat-resistant porous layer 21, and a second heat-resistant porous layer 22, and has pores, preferably uniform pores, therein.

The high molecular porous film 20 can be a porous film made of a high-molecular material, preferably a resin material. The high molecular porous film can be any porous film commonly used in the field of lithium secondary batteries, and a high molecular porous film made of polyolefin such as polyethylene or polypropylene is preferable. The thickness of the high molecular porous film is not particularly limited, but is preferably 3 to 20 μm, and more preferably 5 to 18 μm. Also, the diameter of the pores in the high molecular porous film is preferably in the range of 0.01 to 3 μm.

Also, the porosity of the high molecular porous film 20 at 25° C. is preferably 40 to 70%, and more preferably 40 to 60%. In this case, it is possible to obtain a battery that is excellent in both high-output characteristics and safety. If the porosity is 40 to 70%, the rate of shrinkage is high; however, by providing the first and second heat-resistant porous layers 21 and 22 on both sides of the high molecular porous film 20, the shrinkage of the whole separator 13 can be reduced and battery safety can be enhanced. If the porosity is less than 40%, the high-output characteristics of the battery become insufficient. If the porosity exceeds 70%, the shrinkage of the whole separator 13 increases, so that safety may not be sufficiently improved. The porosity as used herein can be determined, for example, from the weight and thickness of the separator 13 per unit area.

The first heat-resistant porous layer 21 is integrally formed on one face of the high molecular porous film 20 in the thickness direction thereof. The first heat-resistant porous layer 21 includes a heat-resistant high-molecular material, a ceramic filler, and, if necessary, a binder. Due to the inclusion of the heat-resistant high-molecular material and the ceramic filler in combination, the first heat-resistant porous layer 21 has suitable flexibility and sufficient pores for favorably conducting ions therethrough. As used herein, “integrally formed” is also referred to as “integrated”.

The heat-resistant high-molecular material can be a polyamide, polyamideimide, polyimide, cellulose, or a mixture thereof. Among polyamides, aramid resins such as poly-p-phenyleneterephthalamide and poly-p-phenyleneisophthalamide are preferred. Among them, for example, aramid resin and polyamideimide are more preferred. When the heat-resistant high-molecular material is a synthetic resin, its glass transition temperature (Tg) is preferably 130° C. or more. When an aramid resin is used as the heat-resistant high-molecular material, a heat-resistant porous layer is formed, for example, by forming an aramid resin layer in which a water-soluble inorganic material such as calcium chloride is dispersed, and then washing the aramid resin layer with water to remove the water-soluble inorganic material.

The ceramic filler can be any known one, but is preferably an oxide-type ceramic filler such as alumina, silica, titania, zirconia, magnesia, or yttria in terms of heat resistance and chemical stability inside the battery. These ceramic fillers can be used singly or, if necessary, in combination of two or more of them. Among them, an alumina filler is preferred. The ceramic filler preferably has a median diameter of approximately 0.01 to 3 μm. In a preferable mode of the present invention, a polyamideimide is used as the heat-resistant high-molecular material and an alumina filler is used as the ceramic filler. In this case, the flexibility and porosity of the first heat-resistant porous layer 21 are optimized while the heat resistance, the chemical stability inside the battery, etc. are improved. The ratio of the heat-resistant high-molecular material to the ceramic filler is not particularly limited, but the amount of the heat-resistant high-molecular material is preferably 20 to 90% by weight of the first heat-resistant porous layer 21, and more preferably 25 to 75% by weight of the first heat-resistant porous layer 21, with the remainder being the ceramic filler.

The binder is used to enhance, for example, the mechanical strength of the first heat-resistant porous layer 21. The binder can be the same as that used in the active material layer. The amount of the binder is selected as appropriate so as not to impair such characteristics as flexibility and porosity of the first heat-resistant porous layer 21. The thickness of the first heat-resistant porous layer 21 is not particularly limited, but is preferably 0.5 to 10 μm, and more preferably 1 to 8 μm.

The first heat-resistant porous layer 21 can be integrated with the high molecular porous film 20, for example, by laminating the heat-resistant porous film and the high molecular porous film and bonding them together by applying pressure. For example, reduction rollers may be used for applying pressure, and heat may also be applied, if necessary.

The second heat-resistant porous layer 22 is integrally formed on the face of the high molecular porous film 20 opposite to the face integrated with the first heat-resistant porous layer 21 in the thickness direction thereof. The second heat-resistant porous layer 22 includes a heat-resistant high-molecular material, a ceramic filler, and, if necessary, a binder. The heat-resistance high-molecular material and the ceramic filler can be the same as that used in the first heat-resistant porous layer 21. The amounts of the heat-resistant high-molecular material, the ceramic filler, and the binder can be the same as those for the first heat-resistant porous layer 21. Likewise, the preferable combination of the heat-resistant high-molecular material and the ceramic filler is also the combination of a polyamideimide and an alumina filler as in the first heat-resistant porous layer 21. Further, the thickness is also the same as that of the first heat-resistant porous layer 21.

The thickness of the separator 13, composed of the first heat-resistant porous layer 21, the high molecular porous film 20, and the second heat-resistant porous layer 22 which are integrated in this order, is preferably 12 to 24 μm, and more preferably 14 to 20 μm. By setting the thickness of the separator 13 in this range, it is possible to obtain a high-capacity lithium secondary battery capable of charging/discharging stably for an extended period of time and having excellent high-output discharge characteristics. If the thickness is less than 10 μm, the separator 13 provides insufficient insulation, which may result in increased occurrence of internal short-circuits. Also, if the thickness exceeds 24 μm, it is difficult to design a high-capacity lithium secondary battery. Further, for example, the high-output characteristics of the battery may degrade.

Also, in the separator 13, the thickness Da of the high molecular porous film 20, the thickness Db1 of the first heat-resistant porous layer 21, and the thickness Db2 of the second heat-resistant porous layer 22 preferably satisfy the following formula (1). In this case, the separator 13 has improved characteristics such as mechanical strength, so that the shut-down function is exerted in a more reliable manner in the event of abnormal heat generation of the battery. In addition, the occurrence and expansion of a short-circuit is suppressed more effectively, and battery safety is further improved. If this ratio is less than 0.5 and more than 8, the mechanical strength of the separator 13 decreases due to abnormal heat generation or the like, so that the improvement in the effect of suppressing the occurrence and expansion of a short-circuit may become insufficient.

0.5≦Da/(Db1+Db2)≦8 (1)

Further, in the separator 13, the ratio of the thickness Db1 of the first heat-resistant porous layer 21 to the thickness Db2 of the second heat-resistant porous layer 22 (Db1/Db2) is preferably in the range of 0.5 to 2 as shown in the following formula (2). In this case, by bringing the thicknesses of the first and second heat-resistant porous layers 21 and 22 to close to each other, the characteristics of the separator 13 such as mechanical strength are improved. As a result, in the event of abnormal heat generation of the battery, the shut-down function is exerted in a more reliable manner and the shrinkage of the separator 13 can be decreased. Hence, the effect of suppressing the occurrence and expansion of a short circuit becomes remarkable and battery safety can be further enhanced. If the Db1/Db2 ratio is less than 0.5 and more than 2, the improvement in the effect of suppressing the occurrence and expansion of a short-circuit may become insufficient.

0.5≦Db1/Db2≦2 (2)

A preferable mode of the separator 13 is a separator including: a high molecular porous film with a shut-down function, which has a porosity of 40 to 70% at 25° C. and a thickness of Da; a first heat-resistant porous layer which is integrally formed on one face of the high molecular porous film, contains a polyamideimide and an alumina filler, and has a thickness of Db1; and a second heat-resistant porous layer which is integrally formed on the other face of the high molecular porous film, contains a polyamideimide and an alumina filler, and has a thickness of Db2, wherein the sum of Da, Db1, and Db2 is 12 to 24 μm, and Da, Db1 and Db2 satisfy the formulae (1) and (2).

The separator 13 can be prepared by a production method including, for example, an immersing step and a heating/drying step.

In the immersing step, a high molecular porous film is immersed in a coating liquid containing a heat-resistant high-molecular material or a precursor thereof and a ceramic filler, and taken out of the coating liquid. As a result, a layer of the coating liquid is formed on each side of the high molecular porous film. The coating liquid can be prepared, for example, by dissolving or dispersing a heat-resistant high-molecular material or a precursor thereof and a ceramic filler in a solvent. The precursor of a heat-resistant high-molecular material refers to a monomer when the heat-resistant high-molecular material is a resin. A known monomer can be selected as appropriate as the precursor depending on the kind of the heat-resistant high-molecular material. In the case of using a precursor of a heat-resistant high-molecular material, a suitable polymerization initiator may be added to the above-mentioned coating liquid depending on the kind of the precursor. The solvent is not particularly limited as long as it is capable of uniformly dissolving or dispersing a heat-resistant high-molecular material or a precursor thereof and a ceramic filler. Such examples include dimethylformamide, dimethylacetamido, methylformamide, N-methyl-2-pyrrolidone (hereinafter “NMP”), dimethylamine, acetone, cyclohexanone, and solvent mixtures thereof. The solvent may also be selected as appropriate depending on the kind of the heat-resistant high-molecular material or precursor thereof.

The thickness of the finally produced heat-resistant porous layer can be adjusted to a desired value, for example, by adjusting at least one of the viscosity of the coating liquid, the amount of the heat-resistant high-molecular material or precursor thereof, the amount of the ceramic filler, the kind of the high molecular porous film, the immersing time of the high molecular porous film, etc. . . . For example, by increasing the viscosity of the coating liquid, the thickness of the heat-resistant porous layer can be increased. Also, by increasing one or both of the amount of the heat-resistant high-molecular material or precursor thereof and the amount of the ceramic filler, the viscosity of the coating liquid is raised, so that the thickness of the heat-resistant porous layer can be increased.

The heating/drying step is performed following the immersing step. In the heating/drying step, the high molecular porous film with the layer of the coating liquid formed on each side thereof by the immersing step is heated. As a result, the solvent in the coating liquid is dried and removed, so that a heat-resistant porous layer is integrally formed on each side of the high molecular porous film. The heating temperature is not particularly limited and can be selected as appropriate depending on the kind of the solvent contained in the coating liquid, the kind of the precursor of the heat-resistant high-molecular material contained in the coating liquid, etc.

According to this production method, since the first and second heat-resistant porous layers 21 and 22 can be integrally formed, the separator 13 obtained has high mechanical strength. Also, since the first and second heat-resistant porous layers 21 and 22 can be simultaneously formed on both sides of the high molecular porous film 20, this method has high productivity and industrial advantage.

Further, the separator 13 can also be produced by applying the coating liquid onto one face of the high molecular porous film, drying it by heating, applying the coating liquid onto the other face, and drying it by heating. The separator 13 can also be produced by applying the coating liquid onto the surface of an SUS substrate or the like, drying it to form a heat-resistant porous film, sandwiching the high molecular porous films thus produced, and applying pressure thereto. In applying pressure, heat may be applied if necessary. These methods are advantageous, for example, for changing the kind of the heat-resistant high-molecular material and/or ceramic filler contained in the first and second heat-resistant porous layers 21 and 22.

The separator 13 is impregnated with a lithium-ion conductive electrolyte. The lithium-ion conductive electrolyte is preferably a lithium-ion conductive non-aqueous electrolyte. Examples of such non-aqueous electrolytes include liquid non-aqueous electrolyte, gelled non-aqueous electrolyte, and solid electrolyte (e.g., polymer solid electrolyte).

The liquid non-aqueous electrolyte includes a supporting salt, a non-aqueous solvent, and, if necessary, various additives.

The supporting salt can be any salt commonly used in the field of lithium secondary batteries, and examples include LiClO₄, LiBF₄, LiPF₆, LiAlCl₄, LiSbF₆, LISCN, LiCF₃SO₃, LiCF₃CO₂, LiAsF₆, LiB₁₀Cl₁₀, lithium lower aliphatic carboxylate, LiCl, LiBr, LiI, LiBCl₄, borates, and imides. These supporting salts may be used singly or, if necessary, in combination of two or more of them. The amount of the supporting salt dissolved in the non-aqueous solvent is desirably in the range of 0.5 to 2 mol/L.

The non-aqueous solvent can be any solvent commonly used in the field of lithium secondary batteries, and examples include cyclic carbonic acid esters, chain carbonic acid esters, and cyclic carboxylic acid esters. Examples of cyclic carbonic acid esters include propylene carbonate (PC) and ethylene carbonate (EC). Examples of chain carbonic acid esters include diethyl carbonate (DEC), ethyl methyl carbonate (EMC), and dimethyl carbonate (DMC). Examples of cyclic carboxylic acid esters include γ-butyrolactone (GBL) and γ-valerolactone (GVL). These non-aqueous solvents may be used singly or, if necessary, in combination of two or more of them.

Examples of additives include materials that improve charge/discharge efficiency and materials that inactivate the battery. Examples of materials improving charge/discharge efficiency include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate (VEC), divinylethylene carbonate, and such compounds in which part of the hydrogen atom(s) is replaced with fluorine atom(s). They may be used singly or in combination of two or more of them.

Examples of materials that inactivate the battery include benzene compounds that contain a phenyl group and/or a cyclic compound group. A cyclic compound group may be adjacent to the phenyl group. Preferable examples of cyclic compound groups include cyclic ether group, cyclic ester group, cycloalkyl group, and phenoxy group. Specific examples of benzene compounds include cyclohexyl benzene, biphenyl, and diphenyl ether. They can be used singly or in combination of two or more of them. It should be noted, however, that the amount of a benzene compound contained in a liquid non-aqueous electrolyte is preferably 10 parts by volume or less per 100 parts by volume of a non-aqueous solvent.

The gelled non-aqueous electrolyte includes a liquid non-aqueous electrolyte and a high-molecular material for supporting the liquid non-aqueous electrolyte. The high-molecular material used herein is capable of gelling a liquid. The high-molecular material may be any material commonly used in this field, and examples include polyvinylidene fluoride, polyacrylonitrile, polyethylene oxide, polyvinyl chloride, polyacrylate, and polyvinylidene fluoride.

The solid electrolyte includes, for example, a supporting salt and a high-molecular material. The supporting salt can be the same as that as shown above. Examples of high-molecular materials include polyethylene oxide (PEO), polypropylene oxide (PPO), and copolymer of ethylene oxide and propylene oxide.

The lithium secondary battery 1 of the present invention can be used in the same applications as those for conventional lithium secondary batteries, and is useful as the power source, for example, for portable electronic appliances, transport equipment, and uninterruptible power supply systems. Examples of portable electronic appliances include cellular phones, portable personal computers, personal data assistants (PDAs), and portable game machines.

The present invention is hereinafter described specifically by way of Examples.

### EXAMPLE 1

(i) Preparation of Positive Electrode

A positive electrode paste was prepared by mixing and stirring 3 kg of lithium cobaltate, 1 kg of PVDF (trade name: #1320, available from Kureha Corporation, NMP solution with a solid content of 12% by weight), 90 g of acetylene black, and a suitable amount of NMP with a double-arm kneader. This positive electrode paste was intermittently applied onto a 15-μm-thick aluminum foil, dried, rolled, and slit to a width of 57 mm, to obtain a 150-μm thick positive electrode.

(ii) Preparation of Negative Electrode

A negative electrode paste was prepared by mixing and stirring 3 kg of artificial graphite, 75 g of styrene-butadiene copolymer rubber particles (trade name: BM-400B, available from Zeon Corporation, binder with a solid content of 40% by weight), 30 g of carboxymethyl cellulose, and a suitable amount of water with a double-arm kneader. This negative electrode paste was intermittently applied onto a 10-μm thick copper foil, dried, rolled, and slit to a width of 58.5 mm, to obtain a 150-μm thick negative electrode.

(iii) Preparation of Separator

An NMP solution of polyamic acid (polyamic acid concentration of 3.9% by weight) was prepared by adding 21 g of anhydrous trimellitic acid monochloride and 20 g of diaminodiphenylether to 1 kg of NMP, and mixing them at room temperature. In the NMP solution of polyamic acid was dispersed 200 parts by weight of alumina (median diameter 0.3 μm) per 100 parts by weight of polyamic acid, to prepare a coating liquid. A 12-μm thick porous polyethylene film (high molecular porous film) with a porosity of 60% was immersed in this coating liquid, and taken out and dried with hot air of 80° C. (flow rate of 0.5 m/sec) to cause dehydration and cyclization of the polyamic acid. As a result, a 18-μm thick separator with a 3-μm thick polyamideimide resin layer on each side thereof was produced. In this separator, the porous polyethylene film was the high molecular porous film, and the polyamideimide resin layers on both sides of the porous polyethylene film were the heat-resistant porous layers

(iv) Fabrication of Battery

The positive electrode, separator, and negative electrode thus obtained were laminated in this order and wound to form an electrode group with a hollow in the center thereof. The electrode group was placed into a nickel-plated iron battery can, and 5 g of a liquid non-aqueous electrolyte was injected into the hollow of the electrode group. The liquid non-aqueous electrolyte used was prepared by dissolving 1 mol/liter of LiPF₆ and 3% by weight of vinylene carbonate (VC) in a solvent mixture of EC/DMC/EMC (volume ratio 1:1:1). After the injection of the liquid non-aqueous electrolyte, the battery can was sealed to produce a cylindrical lithium secondary battery of size 18650 with a capacity of 2500 mAh.

### EXAMPLE 2

A lithium secondary battery of the present invention was produced in the same manner as in EXAMPLE 1, except that the separator was produced as follows.

Dry anhydrous calcium chloride of 6.5 parts by weight was added to 100 parts by weight of NMP, and dissolved completely by heating in a reaction vessel. The resultant NMP solution containing calcium chloride was allowed to cool to room temperature, and 3.2 parts by weight of paraphenylene diamine was added thereto and dissolved completely. This reaction vessel was placed in a 20° C. constant temperature oven, and 5.8 parts by weight of terephthalic acid dichloride was dropped into the NMP solution in 1 hour to synthesize polyparaphenylene terephthalamide (hereinafter “PPTA”) via polymerization reaction. Thereafter, the reaction vessel was left in the constant temperature oven for 1 hour. After the completion of the reaction, the reaction vessel was transferred to a vacuum chamber, where the resultant solution was stirred under reduced pressure for 30 minutes for degassing. The resultant reaction mixture was diluted with the NMP solution containing calcium chloride, to prepare a PPTA (aramid resin) solution (NMP solution of 1.4% by weight of PPTA). In this PPTA solution was dispersed 200 parts by weight of the same alumina as that of EXAMPLE 1 per 100 parts by weight of PPTA, to prepare a coating liquid. A 12-μm thick porous polyethylene film with a porosity of 60% was immersed in this coating liquid, and taken out while hot air of 80° C. (flow rate 0.5 m/sec) was supplied thereto. As a result, a laminate with an aramid resin layer on each side of the porous polyethylene film was obtained. Thereafter, this laminate was sufficiently washed with pure water to remove the calcium chloride and make the aramid resin layers porous. The laminate was then dried to obtain a 18-μm thick separator with a 3-μm thick aramid resin layer on each side of the porous polyethylene film.

### EXAMPLE 3

A lithium secondary battery of the present invention was produced in the same manner as in EXAMPLE 1, except that the separator was produced as follows.

An NMP solution of polyamic acid (polyamic acid concentration 3.9% by weight) was prepared by mixing 100 parts by weight of NMP, 2.1 parts by weight of pyromellitic dianhydride, and 2.0 parts by weight of diaminodiphenylether at room temperature. In the resultant NMP solution of polyamic acid was dispersed 200 parts by weight of the same alumina as that of EXAMPLE 1 per 100 parts by weight of polyamic acid, to prepare a coating liquid. This coating liquid was applied onto an SUS substrate with a bar coater, and dried with hot air of 80° C. (flow rate 0.5 m/sec), to obtain a coating film of a polyimide precursor. This coating film was removed from the substrate, drawn, and heated at 300° C. to cause dehydration and imidization, to obtain a 3-μm thick heat-resistant porous film of polyimide. A 12-μm-thick porous polyethylene film with a porosity of 60% was sandwiched between two heat-resistant porous films thus produced, and the resultant combination was rolled with heat rollers of 80° C. and integrated under pressure, to obtain a 18-μm thick separator.

### EXAMPLE 4

A lithium secondary battery of the present invention was produced in the same manner as in EXAMPLE 1, except for the use of magnesia with a median diameter of 0.3 μm as the ceramic filler contained in the heat-resistant porous layers of the separator instead of alumina.

### EXAMPLE 5

A lithium secondary battery of the present invention was produced in the same manner as in EXAMPLE 1, except for the use of zirconia with a median diameter of 0.4 μm as the ceramic filler contained in the heat-resistant porous layers of the separator instead of alumina.

### EXAMPLE 6

A lithium secondary battery of the present invention was produced in the same manner as in EXAMPLE 1, except that the separator was produced as follows.

The coating liquid prepared in the same manner as in EXAMPLE 1 was applied onto a smooth SUS plate with an applicator, and the applied coating film was dried with hot air of 80° C. (flow rate 0.5 m/sec) to cause dehydration and cyclization of the polyamic acid. The coating film was removed from the SUS plate to obtain a 1-μm thick heat-resistant porous film of polyamideimide. A 8-μm-thick porous polyethylene film (high molecular porous film) with a porosity of 60% was sandwiched between two heat-resistant porous films thus produced, and the resultant combination was rolled with heat rollers of 80° C. and integrated under pressure, to obtain a 10-μm thick separator.

### EXAMPLE 7

A lithium secondary battery of the present invention was produced in the same manner as in EXAMPLE 6, except that a 12-μm thick separator was produced by changing the thickness of the heat-resistant porous films from 1 μm to 2 μm.

### EXAMPLE 8

A lithium secondary battery of the present invention was produced in the same manner as in EXAMPLE 7, except that a 14-μm thick separator was produced by changing the thickness of the high molecular porous film from 8 μm to 10 μm.

### EXAMPLE 9

A lithium secondary battery of the present invention was produced in the same manner as in EXAMPLE 6, except that a 22-μm thick separator was produced by changing the thickness of the high molecular porous film from 8 μm to 14 μm and changing the thickness of the heat-resistant porous films from 1 μm to 4 μm.

### EXAMPLE 10

A lithium secondary battery of the present invention was produced in the same manner as in EXAMPLE 6, except that a 24-μm thick separator was produced by changing the thickness of the high molecular porous film from 8 μm to 16 μm and changing the thickness of the heat-resistant porous films from 1 μm to 4 μm.

### EXAMPLE 11

A lithium secondary battery of the present invention was produced in the same manner as in EXAMPLE 6, except that a 28-μm thick separator was produced by changing the thickness of the high molecular porous film from 8 μm to 18 μm and changing the thickness of the heat-resistant porous films from 1 μm to 5 μm.

### EXAMPLE 12

A lithium secondary battery of the present invention was produced in the same manner as in EXAMPLE 6, except that a 18-μm thick separator was produced by changing the thickness of the high molecular porous film from 8 μm to 4 μm and changing the thickness of the heat-resistant porous films from 1 μm to 7 μm.

### EXAMPLE 13

A lithium secondary battery of the present invention was produced in the same manner as in EXAMPLE 6, except that a 18-μm thick separator was produced by changing the thickness of the high molecular porous film from 8 μm to 6 μm and changing the thickness of the heat-resistant porous films from 1 μm to 6 μm.

### EXAMPLE 14

A lithium secondary battery of the present invention was produced in the same manner as in EXAMPLE 6, except that a 18-μm thick separator was produced by changing the thickness of the heat-resistant porous films from 1 μm to 5 μm.

### EXAMPLE 15

A lithium secondary battery of the present invention was produced in the same manner as in EXAMPLE 6, except that a 18-μm thick separator was produced by changing the thickness of the high molecular porous film from 8 μm to 10 μm and changing the thickness of the heat-resistant porous films from 1 μm to 4 μm.

### EXAMPLE 16

A lithium secondary battery of the present invention was produced in the same manner as in EXAMPLE 6, except that a 18-μm thick separator was produced by changing the thickness of the high molecular porous film from 8 μm to 14 μm and changing the thickness of the heat-resistant porous films from 1 μm to 2 μm.

### EXAMPLE 17

A lithium secondary battery of the present invention was produced in the same manner as in EXAMPLE 6, except that a 18-μm thick separator was produced by changing the thickness of the high molecular porous film from 8 μm to 16 μm.

### EXAMPLE 18

A lithium secondary battery of the present invention was produced in the same manner as in EXAMPLE 6, except that a 18-μm thick separator was produced by changing the thickness of the high molecular porous film from 8 μm to 17 μm and changing the thickness of the heat-resistant porous films from 1 μm to 0.5 μm.

### EXAMPLE 19

A lithium secondary battery of the present invention was produced in the same manner as in EXAMPLE 6, except that a 18-μm thick separator was produced by changing the thickness of the high molecular porous film from 8 μm to 12 μm and setting the thickness of one heat-resistant porous film to 1 μm and the thickness of the other heat-resistant porous film to 5 μm instead of setting the thicknesses of the two heat-resistant porous films to 1 μm. The thicker heat-resistant porous film of this battery was disposed so as to be in contact with the positive electrode.

### EXAMPLE 20

A lithium secondary battery of the present invention was produced in the same manner as in EXAMPLE 19, except that a 18-μm thick separator was produced by changing the thickness of one heat-resistant porous film from 1 μm to 2 μm and the thickness of the other heat-resistant porous film from 5 μm to 4 μm.

### EXAMPLE 21

A lithium secondary battery of the present invention was produced in the same manner as in EXAMPLE 19, except that a 18-μm thick separator was produced by changing the thickness of one heat-resistant porous film from 1 μm to 2.5 μm and the thickness of the other heat-resistant porous film from 5 μm to 3.5 μm.

### EXAMPLE 22

A lithium secondary battery of the present invention was produced in the same manner as in EXAMPLE 19, except that a 18-μm thick separator was produced by changing the thickness of one heat-resistant porous film from 1 μm to 3.5 μm and the thickness of the other heat-resistant porous film from 5 μm to 2.5 μm.

### EXAMPLE 23

A lithium secondary battery of the present invention was produced in the same manner as in EXAMPLE 19, except that a 18-μm thick separator was produced by changing the thickness of one heat-resistant porous film from 1 μm to 4 μm and the thickness of the other heat-resistant porous film from 5 μm to 2 μm.

### EXAMPLE 24

A lithium secondary battery of the present invention was produced in the same manner as in EXAMPLE 19, except that a 18-μm thick separator was produced by changing the thickness of one heat-resistant porous film from 1 μm to 5 μm and the thickness of the other heat-resistant porous film from 5 μm to 1 μm.

### EXAMPLE 25

A lithium secondary battery of the present invention was produced in the same manner as in EXAMPLE 1, except for the use of a 12-μm thick porous polyethylene film with a porosity of 30% instead of the 12-μm thick porous polyethylene film with a porosity of 60%.

### EXAMPLE 26

A lithium secondary battery of the present invention was produced in the same manner as in EXAMPLE 1, except for the use of a 12-μm thick porous polyethylene film with a porosity of 40% instead of the 12-μm thick porous polyethylene film with a porosity of 60%.

### EXAMPLE 27

A lithium secondary battery of the present invention was produced in the same manner as in EXAMPLE 1, except for the use of a 12-μm thick porous polyethylene film with a porosity of 50% instead of the 12-μm thick porous polyethylene film with a porosity of 60%.

### EXAMPLE 28

A lithium secondary battery of the present invention was produced in the same manner as in EXAMPLE 1, except for the use of a 12-μm thick porous polyethylene film with a porosity of 65% instead of the 12-μm thick porous polyethylene film with a porosity of 60%.

### EXAMPLE 29

A lithium secondary battery of the present invention was produced in the same manner as in EXAMPLE 1, except for the use of a 12-μm thick porous polyethylene film with a porosity of 70% instead of the 12-μm thick porous polyethylene film with a porosity of 60%.

### EXAMPLE 30

A lithium secondary battery of the present invention was produced in the same manner as in EXAMPLE 1, except for the use of a 12-μm thick porous polyethylene film with a porosity of 80% instead of the 12-μm thick porous polyethylene film with a porosity of 60%.

### COMPARATIVE EXAMPLE 1

A lithium secondary battery of COMPARATIVE EXAMPLE 1 was produced in the same manner as in EXAMPLE 6, except that a separator having a heat-resistant porous layer only on one face of a high molecular porous film was produced by bonding a heat-resistant porous layer to only one face of a porous polyethylene film under pressure and changing the thickness of the heat-resistant porous film from 1 μm to 6 μm.

### COMPARATIVE EXAMPLE 2

A lithium secondary battery of COMPARATIVE EXAMPLE 2 was produced in the same manner as in EXAMPLE 1, except that the separator was produced without adding alumina to the coating liquid.

### COMPARATIVE EXAMPLE 3

A lithium secondary battery of COMPARATIVE EXAMPLE 3 was produced in the same manner as in EXAMPLE 1, except that the separator was produced as follows.

A slurry for forming heat-resistant layers was prepared by mixing and stirring 970 g of alumina powder (median diameter 0.3 μm), 375 g of an NMP solution of 8% by weight of modified polyacrylonitrile rubber (binder, trade name: BM-720H, available from Zeon Corporation), and a suitable amount of NMP serving as a dispersion medium with a double-arm kneader. A 12-μm thick porous polyethylene film with a porosity of 60% was immersed in this slurry, and taken out while hot air of 80° C. (flow rate 0.5 m/sec) was supplied thereto. As a result, a separator with a 3-μm thick heat-resistant porous layer formed on each side of the porous polyethylene film was produced.

### COMPARATIVE EXAMPLE 4

A lithium secondary battery of COMPARATIVE EXAMPLE 4 was produced in the same manner as in EXAMPLE 19, except that in producing a separator, the porous polyethylene film and the heat-resistant porous films were just stacked without being integrated under pressure.

### COMPARATIVE EXAMPLE 5

A lithium secondary battery of COMPARATIVE EXAMPLE 5 was produced in the same manner as in EXAMPLE 1, except that the separator was produced as follows.

The coating liquid prepared in the same manner as in EXAMPLE 1 was applied onto a smooth SUS plate with an applicator, and the applied coating film was dried with hot air of 80° C. (flow rate 0.5 m/sec) to cause dehydration and cyclization of the polyamic acid. The coating film was removed from the SUS plate to obtain a 6-μm thick heat-resistant porous film of polyamideimide. This heat-resistant porous film was sandwiched between two 6-μm-thick porous polyethylene films with a porosity of 60%, and the resultant combination was rolled with heat rollers of 80° C. and integrated under pressure, to obtain a 18-μm thick separator.

Table 1 and Table 2 summarize the features of the separators of EXAMPLES 1 to 30 and COMPARATIVE EXAMPLES 1 to 5.

TABLE 1

| | High molecular | | Heat-resistant | | |
|---|---|---|---|---|---|
| | porous film | | porous layer | | |
| | Da | Porosity | Db1 | Db2 | Db1 + Db2 |
| | (μm) | (%) | (μm) | (μm) | (μm) |
| EXAMPLE 1 | 12 | 60 | 3 | 3 | 6 |
| EXAMPLE 2 | 12 | 60 | 3 | 3 | 6 |
| EXAMPLE 3 | 12 | 60 | 3 | 3 | 6 |
| EXAMPLE 4 | 12 | 60 | 3 | 3 | 6 |
| EXAMPLE 5 | 12 | 60 | 3 | 3 | 6 |
| EXAMPLE 6 | 8 | 60 | 1 | 1 | 2 |
| EXAMPLE 7 | 8 | 60 | 2 | 2 | 4 |
| EXAMPLE 8 | 10 | 60 | 2 | 2 | 4 |
| EXAMPLE 9 | 14 | 60 | 4 | 4 | 8 |
| EXAMPLE 10 | 16 | 60 | 4 | 4 | 8 |
| EXAMPLE 11 | 18 | 60 | 5 | 5 | 10 |
| EXAMPLE 12 | 4 | 60 | 7 | 7 | 14 |
| EXAMPLE 13 | 6 | 60 | 6 | 6 | 12 |
| EXAMPLE 14 | 8 | 60 | 5 | 5 | 10 |
| EXAMPLE 15 | 10 | 60 | 4 | 4 | 8 |
| EXAMPLE 16 | 14 | 60 | 2 | 2 | 4 |
| EXAMPLE 17 | 16 | 60 | 1 | 1 | 2 |
| EXAMPLE 18 | 17 | 60 | 0.5 | 0.5 | 1 |
| EXAMPLE 19 | 12 | 60 | 1 | 5 | 6 |
| EXAMPLE 20 | 12 | 60 | 2 | 4 | 6 |
| EXAMPLE 21 | 12 | 60 | 2.5 | 3.5 | 6 |
| EXAMPLE 22 | 12 | 60 | 3.5 | 2.5 | 6 |
| EXAMPLE 23 | 12 | 60 | 4 | 2 | 6 |
| EXAMPLE 24 | 12 | 60 | 5 | 1 | 6 |
| EXAMPLE 25 | 12 | 30 | 3 | 3 | 6 |
| EXAMPLE 26 | 12 | 40 | 3 | 3 | 6 |
| EXAMPLE 27 | 12 | 50 | 3 | 3 | 6 |
| EXAMPLE 28 | 12 | 65 | 3 | 3 | 6 |
| EXAMPLE 29 | 12 | 70 | 3 | 3 | 6 |
| EXAMPLE 30 | 12 | 80 | 3 | 3 | 6 |
| COMP. EXAMPLE 1 | 12 | 60 | 6 | 0 | 6 |
| COMP. EXAMPLE 2 | 12 | 60 | 3 | 3 | 6 |
| COMP. EXAMPLE 3 | 12 | 60 | 3 | 3 | 6 |
| COMP. EXAMPLE 4 | 12 | 60 | 3 | 3 | 6 |
| COMP. EXAMPLE 5 | 6 × 2 | 60 | 6 | 0 | 6 |

TABLE 2

| | Separator | | | Heat-resistant | | |
|---|---|---|---|---|---|---|
| | thickness | Ratio | Ratio | high-molecular | Ceramic | How layers |
| | (μm) | A* | B* | material | Filler | are formed |
| EXAMPLE 1 | 18 | 2.0 | 1.0 | Polyamideimide | Alumina | Integrated |
| EXAMPLE 2 | 18 | 2.0 | 1.0 | Aramid resin | Alumina | Integrated |
| EXAMPLE 3 | 18 | 2.0 | 1.0 | Polyimide | Alumina | Integrated |
| EXAMPLE 4 | 18 | 2.0 | 1.0 | Polyamideimide | Magnesia | Integrated |
| EXAMPLE 5 | 18 | 2.0 | 1.0 | Polyamideimide | Zirconia | Integrated |
| EXAMPLE 6 | 10 | 4.0 | 1.0 | Polyamideimide | Alumina | Integrated |
| EXAMPLE 7 | 12 | 2.0 | 1.0 | Polyamideimide | Alumina | Integrated |
| EXAMPLE 8 | 14 | 2.5 | 1.0 | Polyamideimide | Alumina | Integrated |
| EXAMPLE 9 | 22 | 1.8 | 1.0 | Polyamideimide | Alumina | Integrated |
| EXAMPLE 10 | 24 | 2.0 | 1.0 | Polyamideimide | Alumina | Integrated |
| EXAMPLE 11 | 28 | 1.8 | 1.0 | Polyamideimide | Alumina | Integrated |
| EXAMPLE 12 | 18 | 0.3 | 1.0 | Polyamideimide | Alumina | Integrated |
| EXAMPLE 13 | 18 | 0.5 | 1.0 | Polyamideimide | Alumina | Integrated |
| EXAMPLE 14 | 18 | 0.8 | 1.0 | Polyamideimide | Alumina | Integrated |
| EXAMPLE 15 | 18 | 1.3 | 1.0 | Polyamideimide | Alumina | Integrated |
| EXAMPLE 16 | 18 | 3.5 | 1.0 | Polyamideimide | Alumina | Integrated |
| EXAMPLE 17 | 18 | 8.0 | 1.0 | Polyamideimide | Alumina | Integrated |
| EXAMPLE 18 | 18 | 17.0 | 1.0 | Polyamideimide | Alumina | Integrated |
| EXAMPLE 19 | 18 | 2.0 | 0.2 | Polyamideimide | Alumina | Integrated |
| EXAMPLE 20 | 18 | 2.0 | 0.5 | Polyamideimide | Alumina | Integrated |
| EXAMPLE 21 | 18 | 2.0 | 0.7 | Polyamideimide | Alumina | Integrated |
| EXAMPLE 22 | 18 | 2.0 | 1.4 | Polyamideimide | Alumina | Integrated |
| EXAMPLE 23 | 18 | 2.0 | 2.0 | Polyamideimide | Alumina | Integrated |
| EXAMPLE 24 | 18 | 2.0 | 5.0 | Polyamideimide | Alumina | Integrated |
| EXAMPLE 25 | 18 | 2.0 | 1.0 | Polyamideimide | Alumina | Integrated |
| EXAMPLE 26 | 18 | 2.0 | 1.0 | Polyamideimide | Alumina | Integrated |
| EXAMPLE 27 | 18 | 2.0 | 1.0 | Polyamideimide | Alumina | Integrated |
| EXAMPLE 28 | 18 | 2.0 | 1.0 | Polyamideimide | Alumina | Integrated |
| EXAMPLE 29 | 18 | 2.0 | 1.0 | Polyamideimide | Alumina | Integrated |
| EXAMPLE 30 | 18 | 2.0 | 1.0 | Polyamideimide | Alumina | Integrated |
| COMP. | 18 | 2.0 | — | Polyamideimide | Alumina | Integrated |
| EXAMPLE 1 | | | | | | |
| COMP. | 18 | 2.0 | 1.0 | Polyamideimide | None | Integrated |
| EXAMPLE 2 | | | | | | |
| COMP. | 18 | 2.0 | 1.0 | None | Alumina | Integrated |
| EXAMPLE 3 | | | | | | |
| COMP. | 18 | 2.0 | 1.0 | Polyamideimide | Alumina | Not |
| EXAMPLE 4 | | | | | | integrated |
| COMP. | 18 | 2.0 | — | Polyamideimide | Alumina | Integrated |
| EXAMPLE 5 | | | | | | |

*Ratio A: Da/(Db1 + Db2) Ratio B: Db1/Db2

### TEST EXAMPLE 1

The lithium secondary batteries of EXAMPLES 1 to 30 and COMPARATIVE EXAMPLES 1 to 5 were subjected to the following evaluation tests.

### (Insulation Performance Evaluation)

With respect to each of EXAMPLES 1 to 30 and COMPARATIVE EXAMPLES 1 to 5, 50 batteries were charged to 4.1 V at a current of 500 mA and then stored in an environment at 45° C. for 7 days. When the open circuit voltage of a battery was lower by 300 mV or more after the storage than before the storage, the battery was determined to be internally short-circuited, and the occurrence rate was evaluated. Table 3 shows the results.

### (Nail Penetration Test)

The respective batteries of EXAMPLES 1 to 30 and COMPARATIVE EXAMPLES 1 to 5 were charged under the following conditions. Thereafter, in an environment at 20° C., a 2.7-mm-diameter iron nail was driven into the side face of each battery to a depth of 1.5 mm at a speed of 5 mm/sec, and the battery temperature was measured with a thermocouple fitted to the side face of the battery. Table 3 shows the temperatures after 30 seconds.

Constant current charge: hour rate 1400 mA/end-of-charge voltage 4.3 V

Constant voltage charge: charge voltage 4.3 V/end of charge current 100 mA

### (High-Output Characteristic Evaluation)

The respective batteries of EXAMPLES 1 to 30 and COMPARATIVE EXAMPLES 1 to 5 were discharged at the 0.2 hour rate and the 2 hour rate in an environment at 20° C. in the following conditions, to evaluate high output discharge characteristic. Table 3 shows the percentage (%) of the discharge capacity at the 2 hour rate relative to the discharge capacity at the 0.2 hour rate.

### [Discharge at the 0.2 Hour Rate]

Constant current charge: hour rate 1250 mA/end-of-charge voltage 4.2 V

Constant voltage charge: charge voltage 4.2 V/end of charge current 100 mA

Constant current discharge: hour rate 500 mA/end-of-charge voltage 3.0 V

### [Discharge at the 2 Hour Rate]

Constant current charge: hour rate 1250 mA/end-of-charge voltage 4.2 V

Constant voltage charge: charge voltage 4.2 V/end of charge current 100 mA

Constant current discharge: hour rate 5000 mA/end-of-charge voltage 3.0 V

TABLE 3

| | Insulation | Temperature after | High-output |
|---|---|---|---|
| | performance | nail penetration | characteristic |
| | (%) | (° C.) | (%) |
| EXAMPLE 1 | 0 | 63 | 91.8 |
| EXAMPLE 2 | 0 | 59 | 92.2 |
| EXAMPLE 3 | 0 | 60 | 91.5 |
| EXAMPLE 4 | 0 | 62 | 92.0 |
| EXAMPLE 5 | 0 | 63 | 91.3 |
| EXAMPLE 6 | 12 | 69 | 95.7 |
| EXAMPLE 7 | 4 | 65 | 94.2 |
| EXAMPLE 8 | 2 | 64 | 93.8 |
| EXAMPLE 9 | 0 | 60 | 89.5 |
| EXAMPLE 10 | 0 | 60 | 87.9 |
| EXAMPLE 11 | 0 | 58 | 75.6 |
| EXAMPLE 12 | 0 | 79 | 91.5 |
| EXAMPLE 13 | 0 | 67 | 90.9 |
| EXAMPLE 14 | 0 | 67 | 90.5 |
| EXAMPLE 15 | 0 | 65 | 91.3 |
| EXAMPLE 16 | 2 | 70 | 92.1 |
| EXAMPLE 17 | 0 | 76 | 92.5 |
| EXAMPLE 18 | 0 | 81 | 92.6 |
| EXAMPLE 19 | 0 | 77 | 91.8 |
| EXAMPLE 20 | 0 | 68 | 92.1 |
| EXAMPLE 21 | 0 | 64 | 91.4 |
| EXAMPLE 22 | 0 | 63 | 90.9 |
| EXAMPLE 23 | 0 | 70 | 91.4 |
| EXAMPLE 24 | 0 | 78 | 92.2 |
| EXAMPLE 25 | 0 | 57 | 77.9 |
| EXAMPLE 26 | 0 | 57 | 84.4 |
| EXAMPLE 27 | 0 | 59 | 97.5 |
| EXAMPLE 28 | 0 | 60 | 93.8 |
| EXAMPLE 29 | 0 | 65 | 94.2 |
| EXAMPLE 30 | 0 | 76 | 97.8 |
| COMP. EXAMPLE 1 | 0 | 98 | 93.1 |
| COMP. EXAMPLE 2 | 0 | 63 | 69.5 |
| COMP. EXAMPLE 3 | 0 | 61 | 71.3 |
| COMP. EXAMPLE 4 | 0 | 102 | 91.2 |
| COMP. EXAMPLE 5 | 0 | 105 | 90.8 |

In the insulation performance test, irrespective of EXAMPLES and COMPARATIVE EXAMPLES, almost the same good results were obtained. In the case of EXAMPLE 6, the thickness of the separator is 10 μm, which is less than those of other EXAMPLES and COMPARATIVE EXAMPLES, so the insulation performance was slightly inferior, but was within the practical range.

With respect to the nail penetration test, the following results were obtained.

In the case of the lithium secondary batteries of EXAMPLES 1 to 30, in which the heat-resistant porous layers were bonded to both sides of the high molecular porous film, the battery temperatures after the nail penetration were low. This is probably because shrinkage of the high molecular porous film upon nail penetration was suppressed by the heat-resistant porous layers bonded to both sides thereof. The results of EXAMPLES 3 to 6 indicate that even if the kind of the heat-resistant high-molecular material or ceramic filler is changed, excellent effects can be obtained.

Contrary to this, the battery of COMPARATIVE EXAMPLE 1 exhibited an extremely high battery surface temperature after the nail penetration. The reason is probably as follows. Since the heat-resistant porous layer was provided only on one side, the high molecular porous film shrank due to the generation of heat by an internal short-circuit. Even if the heat-resistant porous layer did not deteriorate or melt, the short-circuited portion expanded, so that the short-circuit current increased, thereby promoting the generation of heat. Also, in the case of COMPARATIVE EXAMPLE 4 in which the high molecular porous film and the heat-resistant porous layers were not bonded together, the battery surface temperature after the nail penetration was extremely high. When the battery after the nail penetration was disassembled, it was found that the heat-resistant porous layers near the nail penetration site were destroyed and that the high molecular porous film was shrunk. This is probably because due to the low mechanical strength of the heat-resistant porous layers, the internal short-circuit continued at the destroyed site.

Also, in the case of COMPARATIVE EXAMPLE 5 in which the high molecular porous films were formed on both sides of the heat-resistant porous layer, the battery surface temperature was also extremely high. In this case, it is also believed that the high molecular porous films on both sides of the heat-resistant porous layer shrank due to the heat generation, so that the heat-resistant porous layer was drawn by the shrinkage, thereby resulting in an expansion of the short-circuit.

Further, in the case of COMPARATIVE EXAMPLE 2 in which the heat-resistant porous layers included only the heat-resistant high-molecular material, and COMPARATIVE EXAMPLE 3 in which the heat-resistant porous layers included only the ceramic filler, the high-output characteristic was extremely low. This is probably because the pore structure of the heat-resistant porous layers was not appropriate, thereby interfering with the ionic conduction upon high output.

When the separator thickness was in the range of 12 to 24 μm, particularly preferable results were obtained. EXAMPLE 6 with a separator thickness of 12 μm or less exhibited poor insulation performance, and EXAMPLE 11 with a thickness of more than 24 μm exhibited a low high-output characteristic.

When the Da/(Db1+Db2) ratio (the ratio of the thickness (Da) of the high molecular porous film to the total thickness (Db1+Db2) of the porous heat-resistant layers) was in the range of 0.5 to 8, preferable results were obtained. EXAMPLE 12 with a ratio of less than 0.5 and EXAMPLE 18 with a ratio of more than 12 exhibited high temperatures after the nail penetration.

When the Db1/Db2 ratio (the ratio of Db1 to Db2) was in the range of 0.5 to 2, preferable results were obtained. EXAMPLE 19 with a ratio of less than 0.5 and EXAMPLE 24 with a ratio of more than 2 exhibited slightly high temperatures after the nail penetration.

When the porosity of the high molecular porous film was in the range of 40 to 70%, preferable results were obtained. EXAMPLE 25 with a porosity of less than 40% exhibited a low high-output characteristic. On the other hand, EXAMPLE 30 with a porosity of more than 70% exhibited a slightly high battery surface temperature after the nail penetration.

The lithium secondary battery of the present invention has high capacity and excellent safety, particularly, significantly high safety against an internal short-circuit of the battery, and is useful, for example, as the power source for portable electronic appliances such as cellular phones.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A separator for a lithium secondary battery, comprising:
a high molecular porous film with a shut-down function;
a first heat-resistant porous layer integrally formed on one face of said high molecular porous film, said first heat-resistant porous layer comprising a heat-resistant high-molecular material and a ceramic filler; and
a second heat-resistant porous layer integrally formed on the other face of said high molecular porous film, said second heat-resistant porous layer comprising a heat-resistant high-molecular material and a ceramic filler.

2. The separator for a lithium secondary battery in accordance with claim 1, wherein said heat-resistant high-molecular material of said first and second heat-resistant porous layers is a polyamideimide, and said ceramic filler of said first and second heat-resistant porous layers is an alumina filler.

3. The separator for a lithium secondary battery in accordance with claim 1, wherein the separator has a thickness of 12 to 24 μm.

4. The separator for a lithium secondary battery in accordance with claim 1, wherein 0.5≦Da/(Db1+Db2)≦8 where Da is the thickness of said high molecular porous film, Db1 is the thickness of said first heat-resistant porous layer, and Db2 is the thickness of said second heat-resistant porous layer.

5. The separator for a lithium secondary battery in accordance with claim 1, wherein 0.5≦Db1/Db2≦2 where Db1 is the thickness of said first heat-resistant porous layer, and Db2 is the thickness of said second heat-resistant porous layer.

6. The separator for a lithium secondary battery in accordance with claim 1, wherein said high molecular porous film has a porosity of 40 to 70% at 25° C.

7. A separator for a lithium secondary battery, comprising:
a high molecular porous film with a shut-down function, said high molecular porous film having a porosity of 40 to 70% at 25° C. and a thickness of Da;
a first heat-resistant porous layer integrally formed on one face of said high molecular porous film, said first heat-resistant porous layer comprising a polyamideimide and an alumina filler and having a thickness of Db1; and
a second heat-resistant porous layer integrally formed on the other face of said high molecular porous film, said second heat-resistant porous layer comprising a polyamideimide and an alumina filler and having a thickness of Db2,
wherein the sum of Da, Db1, and Db2 is 12 to 24 μm, 0.5≦Da/(Db1+Db2)≦8, and 0.5≦Db1/Db2≦2.

8. A method for producing a separator for a lithium secondary battery, comprising the steps of:
immersing a high molecular porous film with a shut-down function in a coating liquid containing a heat-resistant high-molecular material or a precursor thereof and a ceramic filler; and
taking the high molecular porous film out of the coating liquid and heat-drying it to form a heat-resistant porous layer on each side of the high molecular porous film.

9. A lithium secondary battery comprising: the separator of claim 1; a positive electrode comprising an active material which absorbs and desorbs lithium; a negative electrode comprising an active material which absorbs and desorbs lithium; and a non-aqueous electrolyte.
